(19) United States
(12) Patent Application Publication
(10) Pub. No.: US 2026/0307060 A1
(43) Pub. Date: Oct. 8, 2026

(54) SHAPED METAL OXIDES (PEROVSKITES) AND PROCESS FOR PREPARATION THEREOF

(71) Applicant: COUNCIL OF SCIENTIFIC AND INDUSTRIAL RESEARCH, New Delhi (IN)

(72) Inventors: Vinod Chathakudath PRABHAKARAN, Pune (IN); Pawan KUMAR, Pune (IN)

(73) Assignee: COUNCIL OF SCIENTIFIC AND INDUSTRIAL RESEARCH, New Delhi (IN)

(21) Appl. No.: 19/483,026

(22) PCT Filed: May 10, 2024
(86) PCT No.: PCT/IN2024/050509

§ 371 Date: Nov. 10, 2025

(30) Foreign Application Priority Data
May 11, 2023 (IN) 202311033445

(51) Int. Cl. B01J 23/83; B01J 23/00; B01J 35/51; B01J 35/70; B01J 37/06; B01J 37/08

(52) U.S. Cl. CPC B01J 23/83; B01J 23/002; B01J 35/51; B01J 35/733; B01J 37/06; B01J 37/08; B01J 2523/17; B01J 2523/3706; B01J 2523/72; B01J 2523/842

(57) ABSTRACT

The present disclosure relates to a perovskite-based mixed metal oxides represented by the formula ABX3 and a method of preparation thereof. The perovskite-based mixed metal oxide is represented by formula ABX3 wherein A is rare-earth metal(s), alkaline metal(s), ions with a large radius or mixture thereof, B represents transition metal(s), and X is oxygen and the metal oxides have a shape selected from cube, oval, rod or mixture thereof. The invention also relates to obtaining multiple shapes of a single perovskite-based mixed metal oxide with varying exposed facets affording broad tunability of the oxides.

### FIELD OF THE INVENTION

The present invention relates generally to the field of nano-micro structured materials. In particular, the present invention relates to perovskite-based mixed metal oxides represented by formula ABX₃. The present disclosure also relates to a method of synthesizing the perovskite-based mixed metal oxides with the process providing a shape or facet-controlled synthesis.

### BACKGROUND OF THE INVENTION

Facet engineering is an important strategy for tuning the physical, chemical, and electronic properties of a solid shaped surface, and provides an effective route to improve the device performance in many fields. Shape-controlled synthesis and activity of the metal nanoparticles are explored in the field of material science. In the same scenario, mixed metal oxides are also explored in the field of catalysis where synergistic effects between two or more metals clearly play roles in the activity of the materials but, shape or facet-dependent synthesis, as well as activity, has not been explored so far for the mixed metal oxides. If the active facet of the mixed metal oxide can be tuned, it can open up several ways for the scientific community towards the application of the mixed metal oxides.

The perovskite-based mixed metal oxides have interesting physical, chemical properties and diverse applications which can be tuned by crystal symmetry, bond covalency, ionic radii, ordering, d states, polarizability, doping, size and vacancies. Therefore, they have varied applications and can be used in various sectors. In mixed metal oxides, perovskites are a class of inorganic materials that have attracted considerable attention in other areas of materials chemistry but have not been much explored in catalysis. They are known for stability and, if easy and scalable preparation methods are identified, they are the ideal choice as catalysts for fine chemical synthesis. In recent times, perovskite nanomaterials have been used as catalysts for methane activation, CO₂ reduction, epoxidation reaction, etc. In comparison with mixed metal oxide materials, perovskite-type catalysts have higher thermal stability, flexible valence states of transition metal ions in their structure, and redox properties. Further, A or B site cations are usually coordinated by other ions like oxygen, producing defects like oxygen vacancy sites that fine-tune the catalyst's performance. Oxygen mobility in these types of materials is well-known in applications.

Although the existent literature provides methods to obtain various shapes, tuned and/or controlled mixed metals systems, very little has been disclosed for mixed metal oxides. More often, the teachings pertain to core-shell structured metal oxides, microspheres or microcrystals (for e.g. CN108380203B and CN100558640C). There are no teachings on any other shapes of the perovskite-based mixed metal oxides other than some specific shapes like cubes or spheres, or on the different shapes of the same oxides with different exposed facets or on the tunability of the different exposed facets. The known methods are not effective for obtaining large amounts of the mixed metal oxides. The teachings also suffer from numerous drawbacks such as the non-availability of simple, chemical routes for controlling the single phase of the mixed metal oxides, tedious process wherein extensive chemicals are used making the process expensive, the oxides are produced in nanometer scales and the shapes for a singular system are not explored. Most often the literature teachings disclose particles of small size, in nanometers, wherein the morphology is not perfect. Although some literatures explore the stability of perovskite structure mixed with a plurality of support oxide powders for catalysts, they do not provide any teachings on shape and/or facet controlled synthesis of such mixed metal oxides. There are no teachings in the art wherein different shapes of the same mixed metal oxide with different exposed facets are taught. Though perovskite-shaped compounds with tunable facets are highly desirable for their potential in improving the efficiency and stability of the devices or processes where they are employed, the challenges to achieving such compounds with tunable facets and different shapes, facet properties, and several other prospects of facet engineering on perovskite-based mixed metal oxides are abundant such as tenability of the facets, scalability, controlling the single phase of the mixed metal oxides, and therefore, shape-controlled synthesis of perovskite-based metal oxides by means of an easy synthetic route in a scalable manner is a sheer challenge.

Therefore, there exists an urgent need to obtain perovskite-based mixed metal oxides for facet engineering having various shapes such that the numerous facets of the oxides are obtained for effective and optimal applications in the new technological domains. There also exists an urgent need to provide a simple, efficacious process for preparing such perovskite-based mixed metal oxides in a cost effective manner.

### OBJECTS OF THE INVENTION

An object of the present invention is to provide perovskite-based mixed metal oxides represented by the formula ABX₃ with multiple shapes and exposed facets for tunability.

Another object of the present invention is to provide single perovskite-based mixed metal oxide with multiple shapes and exposed facets for tunability.

A further object of the present invention is to provide pure perovskite-based mixed metal oxides by eliminating impurities other than the perovskite phase.

Another object of present invention is to provide process for synthesis of perovskite-based mixed metal oxides represented by formula ABX₃ with multiple shapes and exposed facets for tunability. Another object of the present invention is to provide a process for the synthesis of perovskite-based mixed metal oxides with A site and B site doping.

A further object of the present invention is to provide a process for the large scale synthesis of perovskite-based mixed metal oxides with multiple shapes and exposed facets for tunability. Another object of the present invention is to provide perovskite-based mixed metal oxide with multiple shapes and exposed facets for tunability as catalysts having higher thermal stability, flexible valence states of transition metal ions in their structure, and redox properties.

Yet another object of the present invention is to provide a process for the synthesis of a perovskite-based mixed metal oxide with multiple shapes and exposed facets for tunability that is facile, economical and industrially applicable.

### SUMMARY OF THE INVENTION

The present invention relates to perovskite-based mixed metal oxides having the formula ABX₃ with multiple shapes and exposed facets for tunability.

An aspect of the present invention relates to perovskite-based mixed metal oxides having the formula ABX₃, wherein A is selected from a group consisting of one or more rare-earth metals, one or more alkaline metals, one or more ions with a large radius and mixtures thereof, B is one or more transition metals, and X is oxygen, wherein the mixed-metal oxides have one or more shapes with exposed facets selected from cubic, oval, rod, spherical, orthorhombic, hexagonal, tetragonal or combinations thereof.

In an aspect of the present invention, A is one or more rare-earth metals selected from Lanthanides consisting of La, Ce, Pr and Pm.

In an aspect of the present invention, A is one or more alkaline metals selected from alkaline earth metals consisting of Mg, Ca, Br and Sr.

In an aspect of the present invention, A is one or more ions with a large radius selected from a group consisting of lanthanides and alkaline earth metals selected from La, Ce, Pr, Pm, Mg, Ca, Ba, and Sr.

In an aspect of the present invention, B is one or more transition metals selected from d-block elements consisting of Fe, Mn, Cu, Cr, Co, Ni and Zn.

In an aspect of the present invention, the perovskite-based mixed metal oxide is a La—Fe mixed metal oxide having the shape of cube, oval and rod and size ranging from 2-100 μm.

Specifically, the perovskite-based mixed metal oxide is a La—Fe mixed metal oxide having the shape of cube, hexagonal, oval and rod and size ranging from 2-100 μm.

In an aspect of the present invention, the perovskite-based mixed metal oxide is a La—Cu mixed metal oxide having the shape of sphere and rod and size ranging from 2-20 μm.

In an aspect of the present invention, the perovskite-based mixed metal oxide is a La—Mn mixed metal oxide having the shape of rod and hexagon and size ranging from 2-20 μm.

In an aspect of the present invention, the perovskite-based mixed metal oxide is a La—Ni mixed metal oxide having the shape of rods and size ranging from 2-100 μm.

In an aspect of the present invention, the perovskite-based mixed metal oxide is a La—Co mixed metal oxide having the shape of rods and size ranging from 2-100 μm.

In another aspect, the present invention relates to perovskite-based mixed metal oxides that are bimetallic, trimetallic or multimetallic.

In another aspect, the present invention relates to perovskite-based mixed metal oxides having cube, truncated octahedron or cuboctahedron shapes and having exposed facets of pure or a combination of (100), (110) or (111) facets.

In a further aspect, the present invention relates to perovskite-based mixed metal oxides doped with metals or their salts selected from a group consisting of Cu, Ba, Sr and Mg.

In an aspect of the present invention, the perovskite-based mixed metal oxide is Cu doped La—Fe having elongated cube shape or hexagon shape; or Ba doped La—Fe mixed metal oxides having truncated cube shape in a size ranging from 2-100 μm.

Another aspect of the present invention relates to a process for preparing perovskite-based mixed metal oxides having the formula ABX₃ with multiple shapes and exposed facets for tunability. In an aspect of the present invention, a process for preparing perovskite-based mixed metal oxides having the formula ABX₃, wherein A is selected from a group consisting of one or more rare-earth metals, one or more alkaline metals, one or more ions with a large radius and mixtures thereof, B is one or more transition metals, and X is oxygen, wherein the mixed-metal oxides have one or more shapes with exposed facets selected from cubic, oval, rod, hexagon, spherical, orthorhombic, tetragonal or combinations thereof, comprises the steps of:
(a) providing 2-10 mmol of equimolar solutions of each of the metal precursors corresponding to component A and component B of the formula;
(b) contacting the two metal precursor solutions of step (a) under stirring to obtain a precursor mixture Solution I;
(c) contacting the precursor mixture Solution I of step (b) with a solution of one or more structure directing agents (SDA) in an amount of 1-30 mmol to obtain a Solution II;
(d) exposing the Solution II of step (c) to a temperature ranging from 180° C.-260° C. for a time period ranging from 36-54 h to obtain perovskite-based mixed metal oxides;
(e) washing the mixed metal oxides obtained in step (d) with water;
(f) subjecting the washed mixed metal oxides of step (e) to centrifugation at 7000-9000 rpm for 7-10 mins to obtain a powder;
(g) drying the powder of step (f) at a temperature ranging from 50° C.-70° C.; and
(h) grinding the dried powder of step (g) to a fine powder to obtain the perovskite-based mixed metal oxides.

In another aspect of the present invention, the metal precursor of the component A in the process is selected from a group consisting of La, Ce, Pr, Pm, Mg, Ca, Ba, and Sr.

In another aspect of the present invention, the metal precursors of the component B in the process is selected from a group consisting of Fe, Mn, Cu, Cr, Co, Ni and Zn.

In another aspect of the present invention, the metal precursors of the component A and the component B are mixed in a ratio of 1:5 to 5:1.

In another aspect of the present invention, the one or more structure directing agents are complexing agents selected from a group consisting of urea, potassium hydroxide, citric acid and mixtures thereof.

In another aspect, the present invention relates to a process, wherein the structure directing agent is selected from a group consisting of urea, potassium hydroxide, citric acid and mixtures thereof. In another aspect of the present invention, the perovskite-based mixed metal oxides obtained in step (h) of the process have one or more shapes with exposed facets selected from cubic, oval, rod, spherical, orthorhombic, tetragonal or combinations thereof.

In another aspect of present invention, perovskite-based mixed metal oxides obtained in step (h) of the process are calcined at 500° C.-700° C. to obtain pure perovskite phase of the mixed metal oxides. A further aspect of the present invention provides perovskite-based mixed metal oxides of the formula ABX₃ having one or more shapes selected from cubic, oval, rod, orthorhombic, tetragonal or combinations thereof and having exposed facets for broad tunability, employed as catalysts, oxygen transfer agents and the like.

### BRIEF DESCRIPTION OF THE DRAWINGS

FIG. 1 is FESEM images of KOH-Urea mediated La—Fe based mixed metal oxide, according to an embodiment of the present invention. The morphology of the La—Fe-based mixed metal oxides was investigated. Various shapes (Cube, Oval and Rod) of the LaFeO₃ mixed metal oxides were observed in the investigation. FESEM images of La—Fe-based mixed metal oxides cube (a-c), oval (d-f), hexagonal rod (g-i) of 6 faces and rod (j-1) with 4 faces confirms the different exposed facets of the material.

FIG. 2 is TEM images of KOH-Urea mediated La—Fe based mixed metal oxide, according to an embodiment of the present invention. The nucleation particle for the cube (a-b) was observed here as of oval shape, and no small particles were observed in the case of rods (c-d) and ovals (e-f).

FIG. 3 is HR-TEM images of KOH-Urea mediated La—Fe based mixed metal oxide, according to an embodiment of the present invention. Respective planes for the various exposed facets can be seen by high-resolution transmission electron microscopy. Figures (a), (c) and (e) are the High-resolution TEM images of the various shapes while (b), (d) and (f) are the lattice fringe image of the respective shapes (b-cube, d-oval, f-rod).

FIG. 4 is Elemental mapping of La—Fe mixed metal oxides (cube and rods) according to an embodiment of the present invention. Elemental mapping confirms the homogeneous distribution of the elements throughout the surface of the material. In elemental mapping, the color coding is as follows-(Yellow-Lanthanum, Red-Oxygen and Green-Iron particles). The left figure is for cubic particles and the right figure is for rod-shaped particles.

FIG. 5 is XRD patterns of various KOH-Urea mediated La—Fe mixed metal oxide, according to an embodiment of the present invention. Exposed planes in the various shapes of the materials were investigated using X-Ray diffraction technique. Rods and cube shape particles have the exposed facet of LaFeO₃ while Lanthanum hydroxide is the abundant phase in the case of an oval shaped La—Fe mixed metal oxide.

FIG. 6 is XRD patterns of various KOH-Urea mediated La—Fe mixed metal oxide, according to an embodiment of the present invention. XRD patterns of the various shapes of La—Fe based oxides were compared with the pure LaFeO₃ material synthesized using sol gel method. The Miller indices (hkl) value of the exposed planes was found using the JCPDS data of the pure LaFeO₃.

FIG. 7 is FESEM images of citric acid mediated La—Fe based mixed metal oxide (LFOCA110), according to an embodiment of the present invention. La—Fe based mixed metal oxides were synthesized using citric acid as a complexing agent in the place of urea and KOH. The synthesized material was characterized using electron microscopy and the material was found to be having cubic morphology. This synthesis method for shape-controlled perovskite is the first disclosure in the art and was not explored prior to this disclosure. In the figure, images a-f are the FESEM images of the cubic particle at various scales (10-200 μm).

FIG. 8 is TEM images of citric acid mediated La—Fe based mixed metal oxide: LFOCA105 (a, b); LFOCA110 (c, d); LFOCA115 (e, f); LFOCA120 (g, h), according to an embodiment of the present invention. TEM images of the mixed metal oxides synthesized using citric acid as a complexing agent confirm the morphology pattern with varying citric acid amounts.

FIG. 9 is XRD patterns of citric acid-mediated La—Fe mixed metal oxide, according to an embodiment of the present invention. XRD was further used to confirm the presence of the phase in the mixed metal oxide. Pure perovskite phase was found to be abundant when the citric acid and metal ion molar ratio was 2:1.

FIG. 10 is FESEM analysis of citric acid-mediated La—Cu based mixed metal oxide, according to an embodiment of the present invention. Spherical particles were observed in the case of La—Cu based mixed metal oxides when synthesis was done using citric acid as a complexing agent. In the Figure, image (a)-(c) are the FESEM images of the La—Cu-based oxide while (d) represents the elemental mapping of the material (Green-Lanthanum, Magenta-Copper and Red-Oxygen).

FIG. 11 is FESEM analysis of KOH-Urea mediated La—Cu based mixed metal oxide, according to an embodiment of the present invention. Rod-shaped particles were observed in the case of La—Cu based mixed metal oxides when hydrothermal synthesis was adopted using KOH and urea. In the Figure, images (a)-(c) are the FESEM images of the La—Cu-based oxide while (d) represents the elemental mapping of the material (Green-Lanthanum, Blue-Copper and Red-Oxygen).

FIG. 12 is FESEM analysis of KOH-Urea mediated La—Mn based mixed metal oxide, according to an embodiment of the present invention. Hexagonal and rod-shaped particles were observed in the case of La—Mn based mixed metal oxides when hydrothermal synthesis was adopted using KOH and urea. FIG. (a)-(c) are the FESEM images of hexagonal particle and (d)-(f) are the rod shape particles confirming that the different facets can be exposed by tuning the synthesis method.

FIG. 13 is FESEM analysis of citric acid-mediated La—Mn based mixed metal oxide, according to an embodiment of the present invention. Flakes like morphology was observed in the case of La—Mn based mixed metal oxides when synthesis was done using citric acid as a complexing agent. In the Figure, images (a)-(d) are the FESEM images of the La—Mn-based mixed metal oxide at different scales.

FIG. 14 is FESEM image of KOH-Urea mediated Cu doped La—Fe based mixed metal oxide, according to an embodiment of the present invention. Trimetallic mixed metal oxides were synthesized using the hydrothermal method by B site doping to synthesize defective-shaped perovskites. Elongated cubes and hexagons were observed in the case of said trimetallic system. Figures (a)-(d) are FESEM images of Cu-doped La—Fe mixed metal oxides confirming that the cubes are elongated when B site doping was done.

FIG. 15 is FESEM image of KOH-Urea mediated Ba doped La—Fe based mixed metal oxide, according to an embodiment of the present invention. Trimetallic mixed metal oxides were synthesized using the hydrothermal method by A site doping to synthesize defective-shaped perovskites. Truncated cubes were observed in the case of said trimetallic system. Figures (a)-(d) are the FESEM images of Ba-doped La—Fe mixed metal oxides which confirm the change in the shape during A site doping.

FIG. 16 is XRD patterns of rod shaped La—Fe mixed metal oxide after calcination at high temperatures of 500° C.-700° C., according to an embodiment of the present invention. The pure perovskite phase (LaFeO₃) was abundant when the KOH-Urea-mediated mixed oxides were calcined at high temperatures. LFOHR is the as-synthesized material and LFOHRC is the high temperature (500° C.-700° C.) calcined material.

FIG. 17 is XRD patterns of spherical La—Cu mixed metal oxides after calcination at high temperatures of 500° C.-700° C., according to an embodiment of the present invention. The pure perovskite phase (La₂CuO₄ and CuO) was abundant when the KOH-Urea-mediated mixed oxides were calcined at high temperatures (500° C.-700° C.). LCO is the as-synthesized material and LCO57 is the high temperature (500-700° C.) calcined material.

FIG. 18 is XRD patterns of rod-shaped La—Mn mixed metal oxides after calcination at high temperatures of 500° C.-700° C., according to an embodiment of the present invention. The pure perovskite phase (LaMnO₃) was abundant when the KOH-Urea-mediated mixed oxides were calcined at high temperatures. LMO is the as-synthesized material and LMO5 and LMO7 are the high temperature (500-700° C.) calcined materials.

FIG. 19 is XRD patterns of oval shaped La—Fe mixed metal oxides after calcination at high temperatures of 500° C.-700° C., according to an embodiment of the present invention. The pure perovskite phase (LaFeO₃) was abundant when the KOH-Urea-mediated mixed oxides were calcined at high temperatures. LFOCM is the as-synthesized material and LFOCM500 is the high temperature (500° C.-700° C.) calcined material.

FIG. 20 is FESEM analysis of KOH-Urea mediated La—Ni based mixed metal oxide according to an embodiment of the present invention. Rod-shaped particles were observed in the case of La—Ni-based mixed metal oxides when hydrothermal synthesis was adopted using KOH and urea. Figures (a)-(d) are the FESEM images of the rod shape particles, confirming that the different facets can be exposed by tuning the synthesis method.

FIG. 21 is FESEM analysis of KOH-Urea mediated La—Co based mixed metal oxide according to an embodiment of the present invention. Rod-shaped particles were observed in the case of La—Co-based mixed metal oxides when hydrothermal synthesis was adopted using KOH and urea. Figures (a)-(d) are the FESEM images of the rod shape particles, confirming that the different facets can be exposed by tuning the synthesis method.

FIG. 22 is graphical representation of comparative catalytic activity using methylene blue (MB) degradation; LFO Std=LaFeO₃ pure perovskite synthesized using conventional sol-gel method; LFOC=LaFeO₃ cube shaped according to an embodiment of the present invention; LFOHR=LaFeO₃ hexagonal rod shaped according to an embodiment of the present invention; LFORR=LaFeO₃ rectangular rod shaped according to an embodiment of the present invention; and LC0.2F0.8O=Cu doped LaFeO₃ having 20% and 80% occupancy at B site by Cu and Fe, respectively, according to an embodiment of the present invention.

### DETAILED DESCRIPTION OF THE INVENTION

As used in the description herein and throughout the claims that follow, the meaning of the term ‘bimetallic’ includes where A site and B site are occupied by only 2 metals, for example, La and Fe, respectively.

As used in the description herein and throughout the claims that follow, the meaning of the term ‘trimetallic’ includes where A site or B site have at least two metals, for example, La on A site and Cu and Fe on B site.

As used in the description herein and throughout the claims that follow, the meaning of the term ‘multimetallic’ includes where A site and B site have 2 or more metals, for example, La and Ba on A site and Cu and Fe on B site.

As used in the description herein and throughout the claims that follow, the meaning of the term ‘tunability’ includes regulation or tweaking the properties including physical, chemical, and electronic properties of the mixed-metal oxide by altering its morphology including shape, exposed surface or facet and the like.

As used in the description herein and throughout the claims that follow, the meaning of the term “Miller Indices (hkl)” includes a set of numbers which quantify the intercepts and thus may be used to uniquely identify the plane or surface.

As used in the description herein and throughout the claims that follow, the meaning of the term “facet” refers to external plane faces of a body formed by the solidification of a chemical element, a compound, or a mixture, and has a regularly repeating internal arrangement of atoms which is bound by the external plane faces.

The present invention relates to perovskite-based mixed metal oxides represented by formula ABX₃, wherein A is selected from a group consisting of one or more rare-earth metals, one or more alkaline metals, one or more ions with a large radius and mixtures thereof, B is one or more transition metals, and X is oxygen, and the mixed-metal oxides have one or more shapes with exposed facets selected from cubic, oval, rod, orthorhombic, tetragonal or combinations thereof. The present invention relates to perovskite-based mixed metal oxides having the formula ABX₃ with multiple shapes and exposed facets for broad tunability. The present inventors have in an ingenious manner have achieved multiple shapes of perovskite-based mixed metal oxides that have various exposed facets which can be effectively tuned based on their utility. For a single perovskite-based mixed metal oxide, the present inventors have achieved more than one shape and varied uncovered surface regions increasing the potential applications of the perovskite-based mixed metal oxides. The present invention includes embodiments that relate to an array of faceted structures. The difference in the plane face leads to differences in surface properties. As there is more than one surface adjacent to each other, this can lead to adjacent surfaces having differing properties being functionalized differently by surface treatments.

In an embodiment of present invention, the perovskite-based mixed metal oxides have the formula ABX₃, wherein A is one or more rare-earth metals, one or more alkaline metals, one or more ions with a large radius, or mixtures thereof; B is one or more transition metals; and X is oxygen.

In an embodiment, the perovskite-based mixed metal oxides have one or more shapes with exposed facets selected from cubic, oval, rod, spherical, orthorhombic, tetragonal or combinations thereof.

In an embodiment, the perovskite-based mixed metal oxide is cube shaped, elongated cube shaped, oval shaped, rod shaped, and hexagon shaped.

In an embodiment, A is one or more rare-earth metals selected from Lanthanides consisting of La, Ce, Pr and Pm

In an embodiment, A is one or more alkaline metals selected from alkaline earth metals consisting of Mg, Ca, Br and Sr.

In an embodiment, A is one or more ions with a large radius including but not limited to La, Ce, Pr, Pm, Mg, Ca, Ba, and Sr.

In an embodiment, B is one or more transition metals including but not limited to Fe, Mn, Cu, Cr,

### Co, Ni and Zn.

In preferred embodiment, perovskite-based mixed metal oxides of La with Fe, Mn, Cu, Ni and Co are provided.

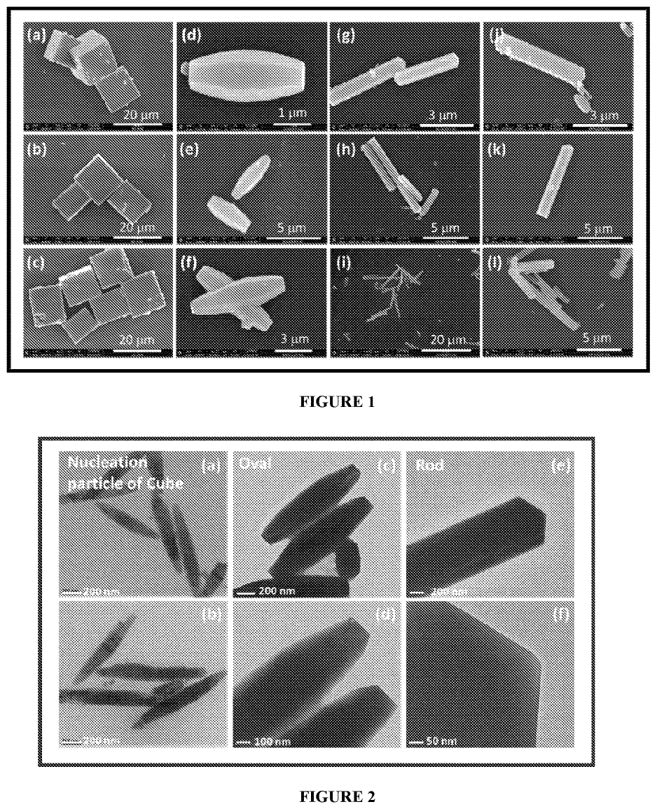

The present inventors have by their ingenuity found that numerous shapes for perovskite-based mixed metal oxides can be obtained by the hydrothermal route by means of suitable structure directing agents. Complexation agents as structure directing agents for obtaining varying shapes and varying exposed facets allowing a broad tunability of the perovskite-based mixed metal oxides has been achieved by the present invention. The dominance of peak(s) in XRD pattern data confirms the shape controlled production of perovskite-based mixed metal oxides. As seen in FIGS. 1-6 and FIGS. 7-9, different shapes of the mixed metal oxides of La—Fe using different structure directing agents lead to distinct differences in the shape and exposed facets of the resultant oxides. Rods and cube shape particles have different exposed facets of the bimetallic LaFeO₃, while lanthanum hydroxide is the abundant phase in the case of an oval shaped La—Fe mixed metal oxide. The formation of cubic LaFeO₃ using citric acid as a complexing agent as disclosed herein is the first such disclosure in the art. Tuning the different exposed facets of the LaFeO₃ is achieved by varying the shapes of the perovskite-based mixed metal oxides and this is the first such report of its kind. The different exposed facets of the mixed metal oxides are responsible for different catalytic activity, making them suitable for a wide range of applications.

In an embodiment of the present invention, the perovskite-based mixed metal oxide is a La—Fe mixed metal oxide having the shape of cube, oval and rod, and size ranging from 5-100 μm.

Different shapes of La—Cu and La—Mn with different exposed facets as disclosed herein are the first such disclosure in the art. Spherical shaped La—Cu perovskite-based mixed metal oxide was obtained when citric acid was employed as the structure directing agent whilst rod shaped particles were observed when KOH and urea was employed in the process. For La—Mn perovskite-based mixed metal oxides prepared using citric acid as the structure directing agent, flakes like morphology was observed whilst hexagonal and rod-shaped particles were obtained when KOH and urea was employed in the process. FIGS. 10-13, 20 & 21 provide the results of such different shapes and exposed facets obtained by the process employing different structure directing agents.

In an embodiment of the present invention, the perovskite-based mixed metal oxide is a La—Cu mixed metal oxide having the shape of spheres and rods and size ranging from 2-20 μm.

In an embodiment of the present invention, the perovskite-based mixed metal oxide is a La—Mn mixed metal oxide having the shape of rods and hexagon and size ranging from 2-20 μm.

In an embodiment of the present invention, the perovskite-based mixed metal oxide is a La—Ni mixed metal oxide having the shape of rods and size ranging from 2-100 μm.

In an embodiment of the present invention, the perovskite-based mixed metal oxide is a La—Co mixed metal oxide having the shape of rods and size ranging from 2-100 μm.

In another embodiment of the present invention, the perovskite has larger domain sites and multiple metals may be inserted in the metal oxide. In preferred embodiments, the perovskite-based mixed metal oxide may be bimetallic, trimetallic or multimetallic.

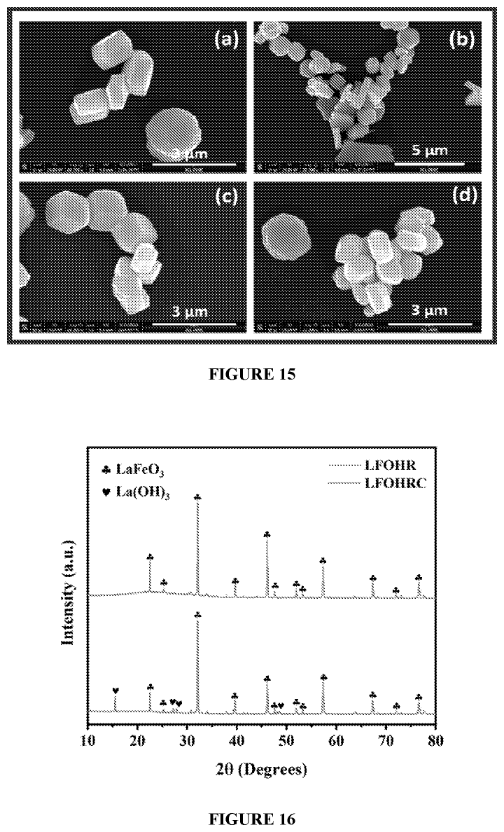

In an aspect of the present invention, the bi-metallic perovskite-based mixed metal oxides are doped at A site or B site to obtain trimetallic mixed metal oxides or defective-shaped perovskites. FIG. 14 shows the FESEM image of Cu doped La—Fe perovskite-based mixed metal oxide obtained by KOH-urea as structure directing agents wherein elongated cubes and hexagons were observed when B site doping was done. FIG. 15 shows FESEM image of Ba doped La—Fe perovskite-based mixed metal oxide obtained by KOH-urea as structure directing agents wherein A site doping resulted in truncated cubes, confirming the change in shape of the doped structures.

In an embodiment of the present invention, the perovskite-based mixed metal oxide is doped with metals or their salts selected from a group consisting of Cu, Ba, Sr, and Mg.

In a preferred embodiment, A site doping is selected from a group consisting of Ba, Sr, Ca and Mg and B site doping is selected from Fe, Mn, Cu, Cr, Co, Ni and Zn.

In an embodiment of the present invention, the perovskite-based mixed metal oxide is Cu doped La—Fe having elongated cube shape or hexagon shape; or Ba doped La—Fe mixed metal oxides having truncated cube shape in a size ranging from 2-100 μm.

In an embodiment, the doping in the A site or B site can be done separately, consequentially or simultaneously.

In yet another embodiment of the present invention, the perovskite-based mixed metal oxide is a cube, truncated octahedron or cuboctahedron having exposed facets of pure or a combination of (100), (110) or (111) facets.

Another aspect of the present invention relates to a process for preparing perovskite-based mixed metal oxides having the formula ABX₃, wherein A is selected from a group consisting of one or more rare-earth metals, one or more alkaline metals, one or more ions with a large radius and mixtures thereof, B is one or more transition metals, and X is oxygen, wherein the mixed-metal oxides have a one or more shapes with exposed facets selected from cube, oval, rod, spherical, orthorhombic, tetragonal or combinations thereof, comprising the steps of:
(a) providing 2-10 mmol of equimolar solutions of each of the metal precursors corresponding to component A and component B of the formula;
(b) contacting the two metal precursor solutions of step (a) under stirring to obtain a precursor mixture Solution I;
(c) contacting the precursor mixture Solution I of step (b) with a solution of one or more structure directing agents (SDA) in an amount of 1-30 mmol to obtain a Solution II;
(d) exposing the Solution II of step (c) to a temperature ranging from 180° C.-260° C. for a time period ranging from 36-54 h to obtain perovskite-based mixed metal oxides;
(e) washing the mixed metal oxides obtained in step (d) with water;
(f) subjecting the washed mixed metal oxides of step (e) to centrifugation at 7000-9000 rpm for 7-10 mins to obtain a powder;
(g) drying the powder of step (f) at a temperature ranging from 50° C.-70° C.; and
(h) grinding the dried powder of step (g) to a fine powder to obtain the perovskite-based mixed metal oxides.

In an embodiment of the present invention, the process involves mixing the metal precursor of the component A including but not limited to La, Ce, Pr, Pm, Mg, Ca, Ba, and Sr and the metal precursors of the component B including but not limited to Fe, Mn, Cu, Cr, Co, Ni and Zn.

In an embodiment of the present invention, the process involves mixing metal precursor solutions corresponding to each of the component A and the component B. Preferably the metal precursors of the component A and the component B are mixed in a ratio of 1:5 to 5:1. In an embodiment, the metal precursors of A and B are mixed in a ratio of 1:5, 1:4, 1:3, 1:2, 1:1 or 5:1, 4:1, 3:1, 2:1. In a preferred embodiment, the metal precursors are mixed in a ratio of 1:1.

In an embodiment of the present invention, the metal precursor is dissolved in water. In a preferred embodiment, the water is de-ionized water.

In an embodiment of the present invention, the each of the metal precursors or component A and component B are dissolved in water in an amount ranging from 2-10 mmol. In another embodiment, the amount of metal precursor amount in water is from 2-9 mmol, 2-7 mmol, 2-5 mmol, 4-6 mmol, 4-8 mmol, 4-10 mmol, 8-10 mmol, 6-10 mmol, 6-8 mmol and so on. In a preferred embodiment, the amount of metal precursors dissolved in water or de-ionized water is preferably 4-8 mmol and most preferably 4 mmol.

The metal precursor solutions are mixed together to obtain a metal precursor mixture solution or Solution I. Preferably, the solutions are mixed by dropwise addition of one solution into another. In an embodiment, the solutions are mixed dropwise and subjected to vigorous stirring.

The metal precursor mixture solution is contacted with one or more structure directing agents (SDA) to obtain a Solution II.

In an embodiment of the present invention, the structure directing agent is a complexation agent including but not limited to urea, potassium hydroxide, citric acid and mixtures thereof.

In an embodiment of the present invention, in step (c) of the process, the structure directing agent is added to Solution I in an amount ranging from 1-30 mmol. In another embodiment, the amount of the structure directing agent is in a range from 1-25 mmol, 5-25 mmol, 10-25 mmol, 15-25 mmol, 20-25 mmol, 2-30 mmol, 2-25 mmol, 2-20 mmol, 2-15 mmol, 3-30 mmol, 4-30 mmol, 5-30 mmol, 10-30 mmol, 10-20 mmol, 10-15 mmol, 15-30 mmol, and 15-20 mmol. In a preferred embodiment, the amount of structure directing agent added to Solution I is 2-24 mmol.

In an embodiment of the present invention, Solution II is heated to a temperature ranging from 120-300° C. for a time period ranging from 10-100 h. Preferably, Solution II is heated at a temperature ranging from 180° C.-260° C. for a time period ranging from 36-54 h to to obtain the perovskite based mixed metal oxides.

As it would be evident to a person skilled in the art, heating at high temperatures may be carried out by any available machines or instruments including, but not limited to autoclave, steel bomb, and ovens. Upon cooling the perovskite based mixed metal oxides to room temperature ranging from 25° C.-40° C., the oxides are washed with a solvent. In a preferred embodiment, the solvent for washing is water.

Subsequent to washing, the oxides are centrifuged at 7000-9000 rpm for 7-10 mins to obtain a powder. In preferred embodiment, oxides are centrifuged at 8000 rpm for 8 mins to obtain a powder

The powder is dried at a temperature ranging from 30° C.-100° C. In some embodiments drying may take place at a temperature of 50° C.-80° C., 40° C.-80° C., 60° C.-100° C., 70° C.-100° C., 50° C.-70° C. or any range in between. In an embodiment of the present invention, in step (g) of the process, the powder is dried at a temperature ranging from 50° C.-70° C., and preferably at 60° C.

Following drying, the powder is ground to a fine powder. The grinding may be carried out by any means known in the art including pressure, sound, or any other mechanical means.

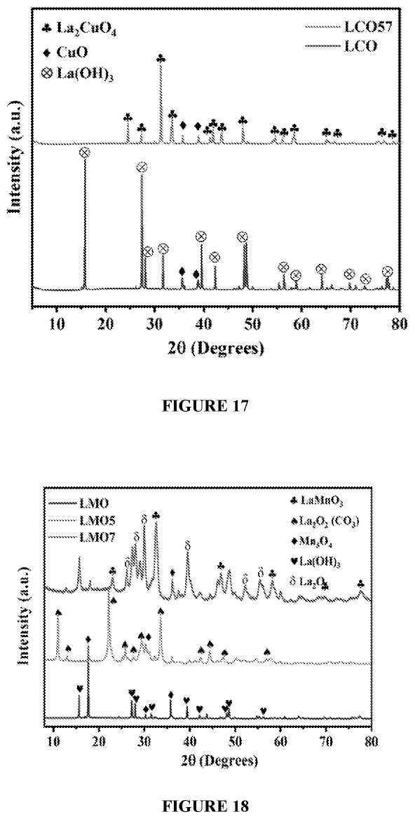

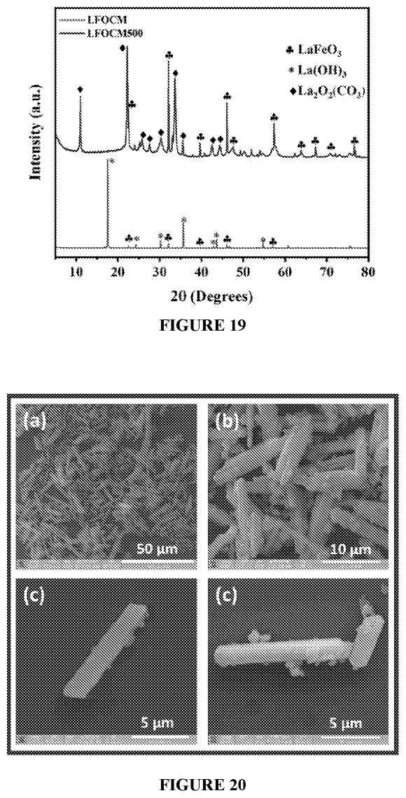

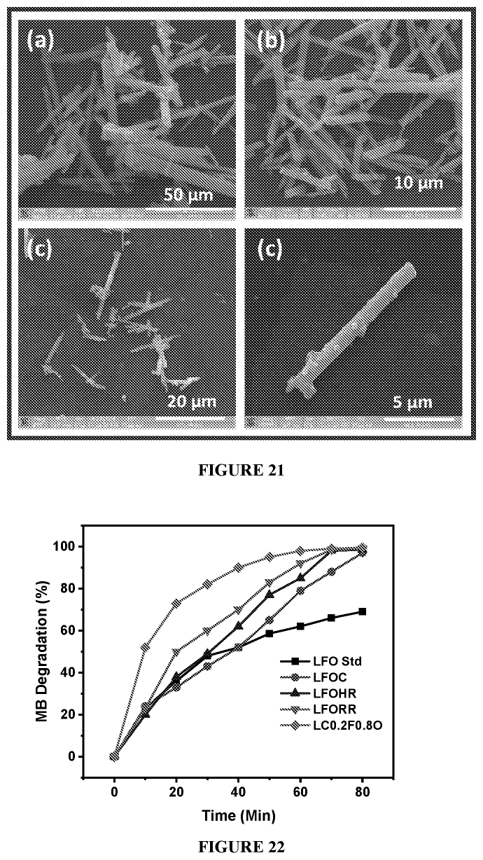

Another aspect of the present invention provides pure perovskite phase of the perovskite-based mixed oxides obtained by the present process by calcination of the fine powder of step (h) to a high temperature. In an embodiment of the present invention, the temperature for calcination is from 400° C.-900° C. and preferably any temperature point in between. In a preferred embodiment, the calcination temperature range is between 500° C.-700° C. FIGS. 16-19 provide the XRD patterns of rod shaped La—Fe mixed metal oxide after calcination, XRD patterns of spherical La—Cu mixed metal oxides after calcination, XRD patterns of rod-shaped La—Mn mixed metal oxides after calcination and XRD patterns of oval shaped La—Fe mixed metal oxides after calcination.

Advantageously, the mixed metal oxides of the present invention can be employed for various purposes like catalysts and in various industries like solar cell production, fuel cell production, oxidation-reduction reactions, heterogeneous catalysis, and oxygen mobility to name a few, based on their properties such as shape, exposed facets and doping elements or metals. The perovskite-based mixed metal oxides obtained by the present invention possess excellent catalytic activity for all their shapes and their exposed facets and also are superior to conventionally prepared metal oxides, as seen in FIG. 22.

Another aspect of the present invention relates to the production scale of the mixed metal oxides. In an embodiment of the present invention, from 10 mL of metal precursor of 0.4M amount, the scalability was tested up to 20 mL resulting in high production of 2-3 g of the perovskite-based mixed metal oxides.

### EXAMPLES

Chemicals/Materials Used: Lanthanum nitrate hexahydrate (purchased from Loba Chemie Pvt. Ltd., India), Ferric nitrate nonahydrate, Citric acid mono hydrate (purchased from Himedia Labs Ltd., India), Copper nitrate tetrahydrate, Manganese nitrate, Potassium hydroxide, Urea (purchased from Merck, India) and all other chemicals were used without further purification.

### Example 1: Preparation of Perovskite-Based Mixed Metal Oxide of La and Fe Using Potassium Hydroxide (KOH) with Urea as Structure Directing Agent

Equimolar aqueous solutions of all the metal nitrates of La and Fe were prepared in 10 mL water. 4 mmol of each metal precursor, Lanthanum nitrate hexahydrate and Ferric nitrate nonahydrate, was dissolved in 10 mL de-ionized water separately. The solutions were mixed by adding one solution to another dropwise under stirring to get Solution I. Solution I was vigorously stirred for 10-15 minutes. Varied amounts of urea for different shapes were added to Solution I. 2.5-5 g of urea was added to solution I and stirred for 5 minutes until complete urea was completely mixed in and Solution II obtained. KOH pellets of about 9 g were introduced into solution II and stirred for 10 to 20 minutes to cool down the mixture to the room temperature of about 25° C.-40° C. Upon cooling, the solution was transferred to the autoclave of 50 mL capacity and packed using the metallic jacket. After packing, the solution was heated for 48 h in a temperature at about 240° C. The autoclaved material which was a mixture of solid and liquid state was cooled to room temperature and washed several times with water. The mixture was centrifuged at 8000 rpm for 8 mins to separate out the powder from the liquid. In the final step, the powder was dried at 60° C. for about 4-6 h and then ground to a fine powder. This fine powder of the La—Fe mixed metal oxide was taken up for analysis and characterization without any further treatments.

TABLE 1
Size parameters of different shapes of KOH-
Urea mediated La-Fe based mixed metal oxides.

| Shape | Length (μm) | Width/Diameter (μm) |
|---|---|---|
| Cube | 10-12 | 10-12 |
| Oval | 2.5-3 | 0.8-1.2 |
| Rod (Hexagonal) | 5-10 | 0.8-0.9 |
| Rod (Trapezium) | 8-12 | 0.8-1.3 |

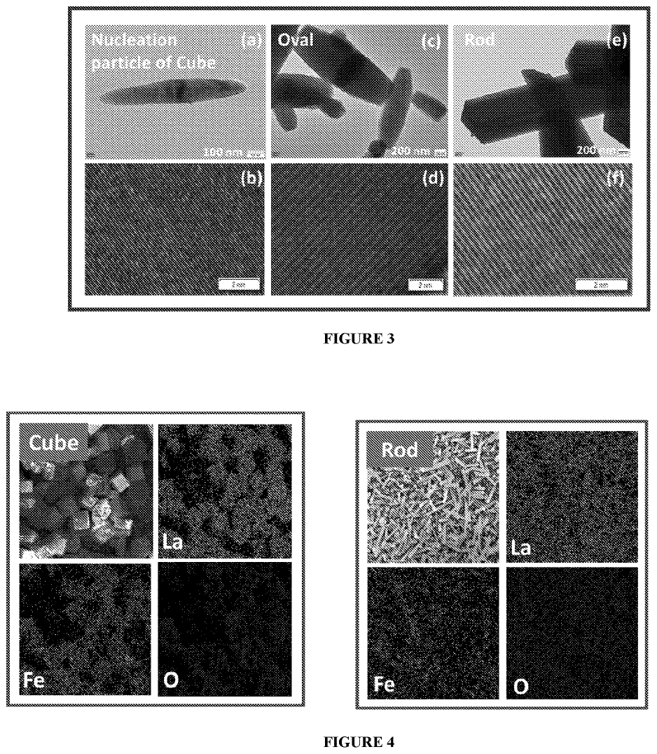

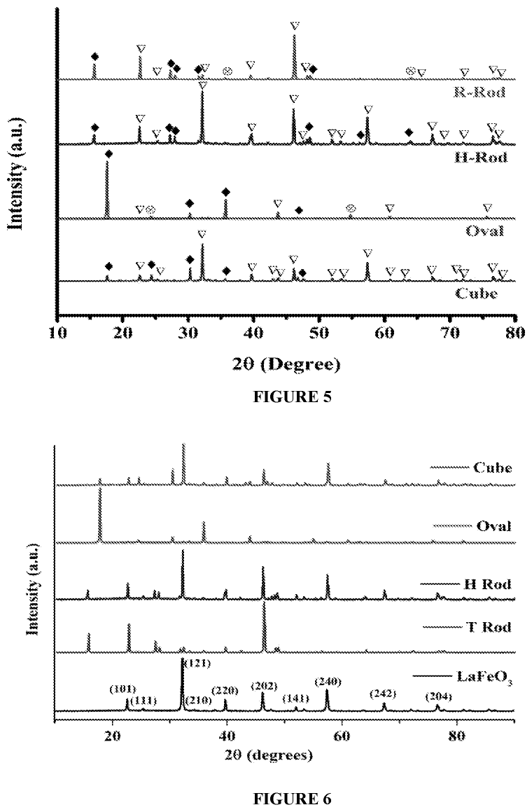

FIG. 1 provides the FESEM images of La—Fe-based mixed metal oxides having shapes of cube (a-c), oval (d-f), hexagonal rod (g-i) of 6 faces and rod (j-l) with 4 faces confirming the different exposed facets of the mixed metal oxide. FIG. 2 is TEM images of KOH-Urea mediated La—Fe based mixed metal oxide. The nucleation particle for the cube (a-b) was observed as oval shape, whilst no small particles were observed in the case of rods (c-d) and ovals (e-f). FIG. 3 is HR-TEM images of KOH-Urea mediated La—Fe based mixed metal oxide. Respective planes for the various exposed facets can be seen by high-resolution transmission electron microscopy. Figures (a), (c) and (e) are the High-resolution TEM images of the various shapes while (b), (d) and (f) are the lattice fringe image of the respective shapes (b-cube, d-oval, f-rod). FIG. 4 is Elemental mapping of La—Fe mixed metal oxides (cube and rods) which confirms the homogeneous distribution of the elements throughout the surface of the material. In elemental mapping, the color coding is as follows-(Yellow-Lanthanum, Red-Oxygen and Green-Iron particles). The left figure is for cubic particles and the right figure is for rod-shaped particles. FIG. 5 is XRD patterns of various KOH-Urea mediated La—Fe mixed metal oxide. Exposed planes in the various shapes of the materials were investigated using X-Ray diffraction technique. Rods and cube shape particles have the exposed facet of LaFeO₃ while Lanthanum hydroxide is the abundant phase in the case of an oval shaped La—Fe mixed metal oxide. FIG. 6 is XRD patterns of various KOH-Urea mediated La—Fe mixed metal oxide. XRD patterns of the various shapes of La—Fe based oxides were compared with the pure LaFeO₃ material synthesized using sol gel method. The Miller indices (hkl) value of the exposed planes was found using the JCPDS data of the pure LaFeO₃.

### Example 2: Preparation of Perovskite-Based Mixed Metal Oxide of La and Cu Using Citric Acid as Structure Directing Agent

Equimolar aqueous solutions of the metals La and Cu were prepared in 10 mL water. 4 mmol of each metal precursor, Lanthanum nitrate hexahydrate and Copper (II) nitrate trihydrate, was dissolved in 10 mL de-ionized water. 16 mmol citric acid was dissolved in 10 mL of deionized water. The aqueous solution of metals was added dropwise to the citric acid solution under stirring and the final solution stirred for 1-4 h. Subsequently, the solution was transferred to the autoclave of 50 mL capacity, packed using the metallic jacket, and heated for about 48 h in a temperature of about 240° C. The autoclaved material, a mixture of solid and liquid state, was cooled down to a temperature of about 25° C.-40° C. and washed several times using water. The washed mixture was then centrifuged at 8000 rpm for 8 mins and the powder separated out from the liquid. The powder was then dried at 60° C. for 4 h-6 h and then ground to a fine powder, and characterized without any further treatment. This fine powder of the La—Cu mixed metal oxide was taken up for analysis and characterization without any further treatments.

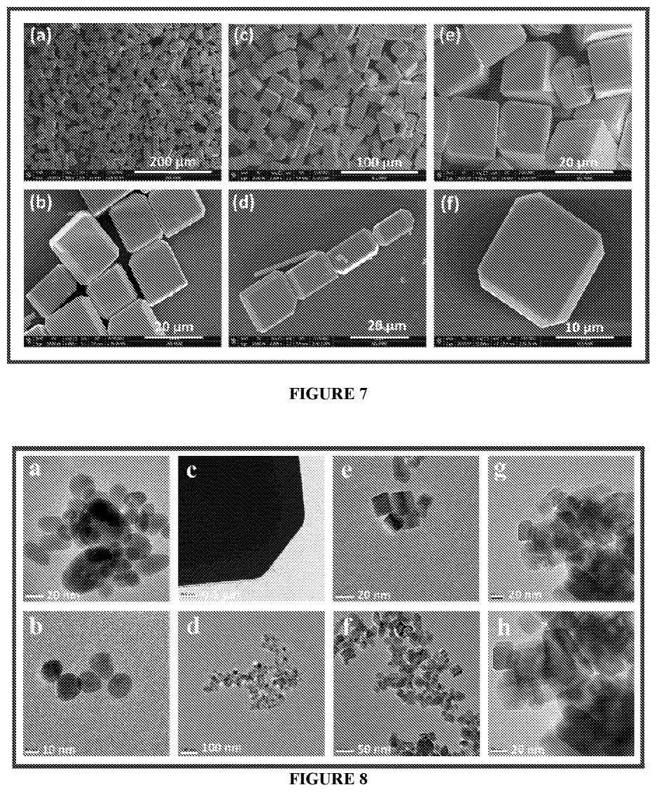

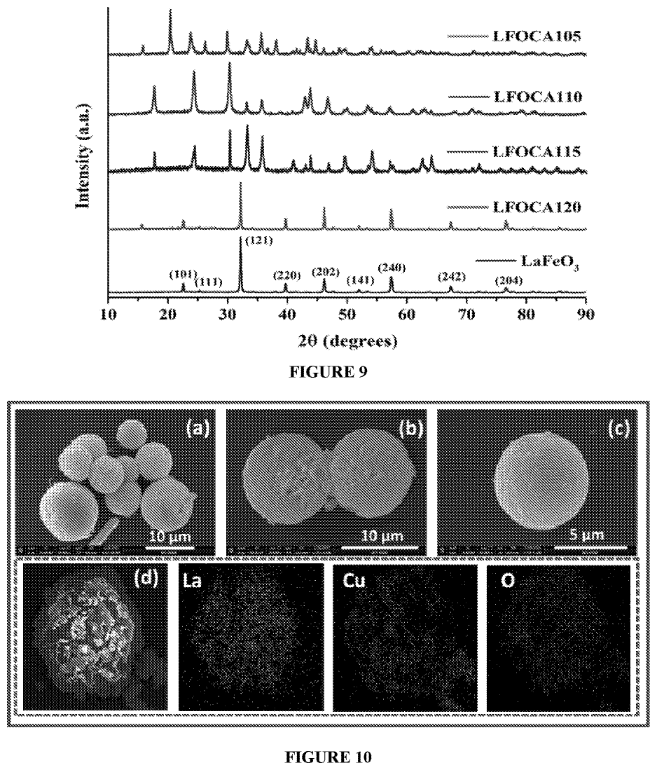

FIG. 7 is FESEM images of citric acid mediated La—Fe based mixed metal oxide (LFOCA110). La—Fe based mixed metal oxides were synthesized using citric acid as a complexing agent in the place of urea and KOH. The synthesized material was characterized using electron microscopy and the material was found to be having cubic morphology. This synthesis method for shape-controlled perovskite is the first disclosure in the art and was not explored prior to this disclosure. In the figure, images a-f are the FESEM images of the cubic particle at various scales (10-200 μm). FIG. 8 is TEM images of citric acid mediated La—Fe based mixed metal oxide: LFOCA105 (a, b); LFOCA110 (c, d); LFOCA115 (e,f); LFOCA120 (g, h). TEM images of the mixed metal oxides synthesized using citric acid as a complexing agent confirm the morphology pattern with varying citric acid amounts. FIG. 9 is XRD patterns of citric acid-mediated La—Fe mixed metal oxides. XRD was further used to confirm the presence of the phase in the mixed metal oxide. Pure perovskite phase was found to be abundant when the citric acid and metal ion molar ratio was 2:1. It can be seen from the above examples that cube-, oval- and rod-shaped mixed metal oxides of La—Fe were formed when the structure directing agent KOH-Urea were employed, and cubic shaped material were formed when the structure directing agent was citric acid. Without wishing to be bound by theory, the present inventors present that by the process disclosed herein and the structure directing agents used in the process, more than one shape can be arrived at for a single perovskite-based mixed metal oxide.

The powdered perovskite-based mixed metal oxide was further subjected to calcination at a temperature ranging from 500° C. to 700° C. to obtain pure perovskite phase of the mixed metal oxide and remove any impure phases. FIGS. 16-19 provide the XRD patterns of rod shaped La—Fe mixed metal oxide after calcination, XRD patterns of spherical La—Cu mixed metal oxides after calcination, XRD patterns of rod-shaped La—Mn mixed metal oxides after calcination and XRD patterns of oval shaped La—Fe mixed metal oxides after calcination.

### Example 3: Comparison of Various Shapes of the La—Fe-Based Metal Oxides Synthesized Using Different Structure Directing Agents/Methods

Lanthanum-metal precursor La(NO3)3·6H2O and Iron-metal precursor Fe(NO3)3·9H2O were mixed with the desired mole ratio in 20 ml distilled water (18 MΩ cm) under stirring at 70° C. for 1 h. Citric acid was added to the metal salts at a molar ratio of 1:2 (total metal ion/citric acid) to ensure the complete complexation of metal ions. The resulting solution was stirred at 70° C. to form a gel. The gel was then dried at 70-100° C. for 12 h to remove any traces of water. The hygroscopic material was then calcined in 2 steps, first at a temperature of 400° C. for 4 h followed by heating at 800° C. for 4 h.

TABLE 2
Various shapes of La-Fe-based mixed metal
oxides synthesized by different methods.

| Material | Synthesis method | Morphology |
|---|---|---|
| LaFeO₃ pure | Sol-gel method | — |
| LaFeO₃ | Hydrothermal | Cube, Oval, Rod |
| LaFeO₃ | Citric acid - complexing agent | Cubes |

### Example 4: Comparison of Various Shapes of the La—Cu Based Metal Oxides Synthesized Using Different Structure Directing Agents

The La—Cu mixed metal oxides using different structure directing agents were prepared as provided in Examples 1 & 2 above.

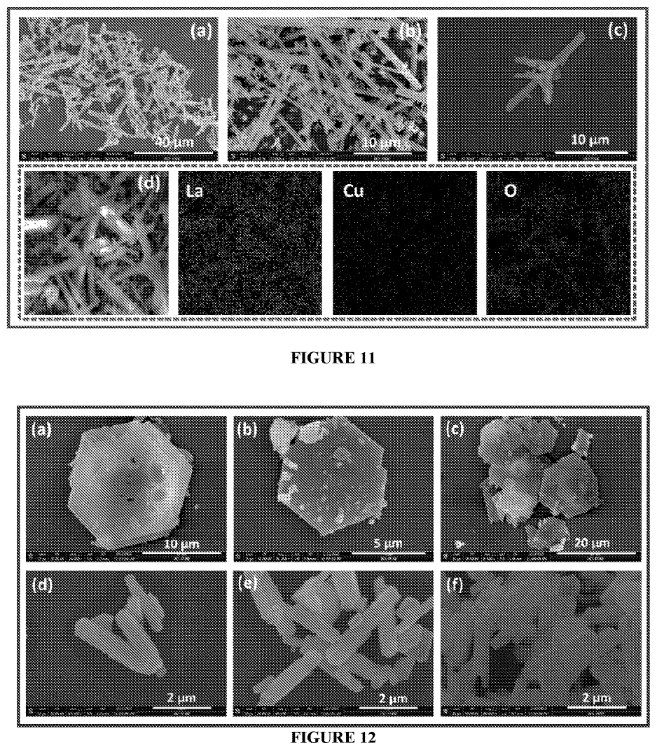

FIG. 10 is FESEM analysis of citric acid-mediated La—Cu based mixed metal oxide. Spherical particles were observed in the case of La—Cu based mixed metal oxides when synthesis was done using citric acid as a complexing agent. In the Figure, image (a)-(c) are the FESEM images of the La—Cu-based oxide while (d) represents the elemental mapping of the material (Green-Lanthanum, Magenta-Copper and Red-Oxygen). FIG. 11 is FESEM analysis of KOH-Urea mediated La—Cu based mixed metal oxide. Rod-shaped particles were observed in the case of La—Cu based mixed metal oxides when hydrothermal synthesis was adopted using KOH and urea. In the Figure, images (a)-(c) are the FESEM images of the La—Cu-based oxide while (d) represents the elemental mapping of the material (Green-Lanthanum, Blue-Copper and Red-Oxygen).

### Example 5: Obtaining Different Facets of the La—Mn Based Metal Oxides

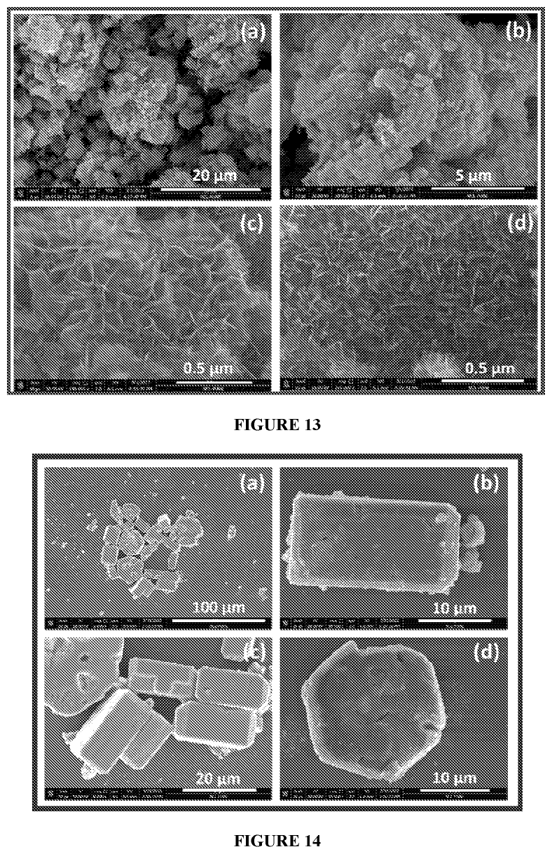

The amount of KOH and urea was varied in the synthesis process to tune the morphology of the mixed metal oxides. FIG. 12 is FESEM analysis of KOH-Urea mediated La—Mn based mixed metal oxide. Hexagonal and rod-shaped particles were observed in the case of La—Mn based mixed metal oxides when hydrothermal synthesis was adopted using KOH and urea. FIG. (a)-(c) are the FESEM images of hexagonal particle and (d)-(f) are the rod shape particles confirming that the different facets can be exposed by tuning the synthesis method. FIG. 13 is FESEM analysis of citric acid-mediated La—Mn based mixed metal oxide. Flakes like morphology was observed in the case of La—Mn based mixed metal oxides when synthesis was done using citric acid as a complexing agent. In FIG. image a-d are FESEM images of La—Mn-based oxide at different scales.

### Example 6: Effects of Doping Sites on the Shapes and Exposed Facets of the Mixed Metal Oxides

The doping was done by changing the molar ratio of the metals at either A site or B site and managing the equimolar ratio for the A site and B site. For example, if the Cu was doped at the B site in the La—Fe-based perovskite system, then 4 mmol of La precursor and x moles of Fe and y mmol of Cu were taken where x+y is 4. For the synthesis, all the process steps were the same as mentioned in Example 1 above for the La—Fe based perovskite mixed metal oxide.

FIG. 14 is FESEM images of KOH-Urea mediated Cu doped La—Fe based mixed metal oxide. Trimetallic mixed metal oxides were synthesized using the hydrothermal method by B site doping to synthesize defective-shaped perovskites. Elongated cubes and hexagons were observed in the case of said trimetallic system. Figures (a)-(d) are FESEM images of Cu-doped La—Fe mixed metal oxides confirming that the cubes are elongated when B site doping was done. FIG. 15 is FESEM image of KOH-Urea mediated Ba doped La—Fe based mixed metal oxide. Trimetallic mixed metal oxides were synthesized using the hydrothermal method by A site doping to synthesize defective-shaped perovskites. Truncated cubes were observed in the case of said trimetallic system. Figures (a)-(d) are the FESEM images of Ba-doped La—Fe mixed metal oxides which confirm the change in the shape during A site doping.

### Example 7: Functional Activity of the Mixed Metal Oxides

The catalytic activity of the perovskite-based mixed metal oxides as prepared by the method of the foregoing examples was measured using methylene blue (MB) degradation. Comparison of the activities of the differently synthesized and differently shaped metal oxides was carried out. For the synthesis of LaFeO₃ using the conventional sol-gel method, 3.96 g of lanthanum nitrate and 3.70 g of iron nitrate were dissolved in 20 mL of distilled water. In a second beaker, 3.52 g of citric acid was dissolved in 10 mL of distilled water. The molar ratios nLa/nFe=1 and (nLa+nFe)/ncitric acid=1 were maintained. Then, the two solutions were mixed under magnetic stirring for 1 hour at room temperature. The solution was concentrated in a rotary evaporator to remove the excess water at 70° C. until the gel formed. The gel was then heated in a muffle furnace at 70° C. for 12 h, at 400° C. for 4 h in the air with heating rates of 5° C./min, and finally at 800° C. in the air for 4 h at heating rate of 5° C./min. The resulting powder was named as LFO Std.

The photocatalytic activity of the prepared perovskites was evaluated by measuring the catalytic activity in 50 mL of anaqueous solution of 0.025 mol/L of MB with 0.5 g/L of catalyst at 25° C. in a round bottom flask with 150 rpm stirring for 1-2 h. Eventually, hydrogen peroxide 3-6 g/L was added to the samples to determine the optimum reagent for the following tests. Moreover, a lamp of UVA light was used in the samples. In each test, 3 mL of samples were collected every 20 minutes and characterized in a spectrophotometer UV. The absorbance band of MB at 665 nm was used for concentration comparison according to the following equation derived from Beer-Lambert law.

$$Ct / Co = At / Ao$$

Where Ao is the absorbance in t=0, At the absorbance at time t, Co is the initial concentration and Ct is the concentration at time t.

FIG. 22 provides the catalytic activity comparison of various catalysts for methylene blue degradation, including LFO Std=LaFeO₃ pure perovskite synthesized using sol-gel method, LFOC=LaFeO₃ Cube, LFOHR=LaFeO₃ hexagonal rod, LFORR=LaFeO₃ rectangular rod, and LC0.2F0.80=Cu doped LaFeO₃ having 20% and 80% occupancy at B site by Cu and Fe respectively. It was observed that methylene blue degration was comparatively higher for all the shapes of the La—Fe perovskite-based mixed metal oxides prepared by the process of the present invention compared to the conventionally prepared LaFeO₃. Interestingly, the methylene blue dye degraded up to 99% within 60 minutes by the Cu-doped La—Fe perovskite-based mixed metal oxide of the present invention (LC0.2F0.80) compared to 60% dye degradation by the LaFeO₃ perovskite prepared using the conventional sol-gel method (LFORStd) indicating a very high catalytic activity of the Cu-doped La—Fe perovskite-based mixed metal oxide of the present invention.

### Example 8: Scalability Experiments for the Mixed Metal Oxides

10 mL of metal precursor of 0.4M amount was taken and the scalability was tested up to 20 mL which results in the production of 2-3 g of the mixed metal oxide. The amount of the metals precursors can be increased to increase the yield of the mixed metal oxides. Instead of 4 mmol in 10 ml of metal precursor as shown in examples 1 and 2 above, the metal precursor amount can be increased to 8 or 16 mmol whilst maintaining the A site and B site ratio as 1:1 which increases the yield of the mixed metal oxides.

### ADVANTAGES OF THE PRESENT INVENTION

The present invention provides perovskite-based mixed metal oxides represented by formula ABX₃ with more than one or multiple shapes for a single perovskite-based mixed metal oxide. The present invention provides perovskite-based mixed metal oxides having multiple shaped and exposed facets affording broad tunability of the oxides for various applications. The present invention provides a process of preparing perovskite-based mixed metal oxides having different shapes. The present invention provides a process of preparing perovskite-based mixed metal oxides that is scalable and the mixed metal oxides with more than one or multiple shapes can be prepared at a large scale. The present invention provides a process of preparing a multi-metallic system i.e. both A site and B site doping perovskite oxides. The present invention provides a process of preparing perovskite-based mixed metal oxides that is facile, economical and industrially applicable. The present invention provides perovskite based mixed metal oxide catalysts that have higher thermal stability, flexible valence states of transition metal ions in their structure, and redox properties compared to normal metal oxides.

1. Perovskite-based mixed metal oxides having the formula ABX₃, wherein A is selected from a group consisting of one or more rare-earth metals, one or more alkaline metals, one or more ions with a large radius and mixtures thereof, B is one or more transition metals, and X is oxygen, wherein the mixed-metal oxides have one or more shapes with exposed facets selected from cubic, oval, rod, spherical, orthorhombic, tetragonal, hexagonal or combinations thereof.

2. The perovskite-based mixed metal oxides as claimed in claim 1, wherein A is one or more rare-earth metals selected from Lanthanides consisting of La, Ce, Pr and Pm; or A is one or more alkaline metals selected from alkaline earth metals consisting of Mg, Ca, Br and Sr; or A is one or more ions with a large radius selected from a group consisting of lanthanides and alkaline earth metals selected from La, Ce, Pr, Pm, Mg, Ca, Ba, and Sr.

3. The perovskite-based mixed metal oxides as claimed in claim 1, wherein B is one or more transition metals selected from d-block elements consisting of Fe, Mn, Cu, Cr, Co, Ni and Zn.

4. The perovskite-based mixed metal oxides as claimed in claim 1, wherein the mixed metal oxide is a La—Fe mixed metal oxide having the shape of cube, oval, and rod, and size ranging from 2-100 μm, or a La—Cu mixed metal oxide having the shape of spheres and rods and size ranging from 2-20 μm, or a La—Mn mixed metal oxide having the shape of rod and hexagon and size ranging from 2-20 μm, or a La—Ni mixed metal oxide having the shape of rod and size ranging from 2-100 μm, or a La—Co mixed metal oxide having the shape of rod and size ranging from 2-100 μm.

5. The perovskite-based mixed metal oxides as claimed in claim 1, wherein the mixed metal oxide is bimetallic, trimetallic or multimetallic.

6. The perovskite-based mixed metal oxides as claimed in claim 1, wherein the mixed metal oxide is a cube, truncated octahedron or cuboctahedron having exposed facets of pure or a combination of (100), (110) or (111) facets.

7. The perovskite-based mixed metal oxides as claimed in claim 1, wherein the mixed metal oxide is doped with metals or their salts selected from a group consisting of Cu, Ba, Sr, and Mg.

8. The perovskite-based mixed metal oxides as claimed in claim 7, wherein the mixed metal oxide is Cu doped La—Fe having elongated cube shape or hexagon shape; or Ba doped La—Fe mixed metal oxides having truncated cube shape in a size ranging from 2-100 μm.

9. A process for preparing perovskite-based mixed metal oxides having the formula ABX₃ as claimed in claim 1, comprising the steps of:
a) providing2-10 mmol of equimolar solutions of each of the metal precursors corresponding to component A and component B of the formula;
b) contacting the two metal precursor solutions of step (a) under stirring to obtain a precursor mixture solution I;
c) contacting the precursor mixture solution I of step (b) with a solution of one or more structure directing agents (SDA) in an amount of 1-30 mmol to obtain a solution II;
d) exposing the solution II of step (c) to a temperature ranging from 180° C.-260° C. for a time period ranging from 36-54 h to obtain perovskite-based mixed metal oxides;
e) washing the mixed metal oxides obtained in step (d) with water;
f) subjecting the washed mixed metal oxides of step (e) to centrifugation at 7000-9000 rpm for 7-10 minutes to obtain a powder;
g) drying the powder of step (f) at a temperature ranging from 50° C.-70° C.; and
h) grinding the dried powder of step (g) to a fine powder to obtain the perovskite-based mixed metal oxides.

10. The process as claimed in claim 9, wherein the metal precursor of the component A is selected from a group consisting of La, Ce, Pr, Pm, Mg, Ca, Ba, and Sr and the metal precursors of the component B is selected from a group consisting of Fe, Mn, Cu, Cr, Co, Ni and Zn.

11. The process as claimed in claim 9, wherein the metal precursors of the component A and the component B are mixed in a ratio of 1:5 to 5:1.

12. The process as claimed in claim 9, wherein the one or more structure directing agents are complexing agents selected froma group consisting of urea, potassium hydroxide, citric acid and mixtures thereof.

13. The process as claimed in claim 9, wherein the perovskite-based mixed metal oxides obtained in step (h) have one or more shapes with exposed facets selected from cube, oval, rod, rhombic, orthogonal or tetragonal.

14. The process as claimed in claim 9, wherein the perovskite-based mixed metal oxides obtained in step (h) are calcined at 500° C.-700° C. for obtaining pure perovskite phase of the mixed metal oxides.
